(19) United States
(12) Patent Application Publication
(10) Pub. No.: US 2009/0089684 A1
(43) Pub. Date: Apr. 2, 2009

(54) SYSTEMS, METHODS, AND MEDIA FOR TEMPORAL TELEPORT IN A VIRTUAL WORLD ENVIRONMENT

(76) Inventors: Gregory J. Boss, American Fork, UT (US); Christopher J. Dawson, Arlington, VA (US); Rick A. Hamilton, II, Charlottesville, VA (US); Clifford A. Pickover, Yorktown Heights, NY (US); James W. Seaman, Falls Church, VA (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(21) Appl. No.: 11/865,412

(22) Filed: Oct. 1, 2007

(51) Int. Cl. G06F 3/048; G06F 15/16

(52) U.S. Cl. 715/757

(57) ABSTRACT

Generally speaking, systems, methods and media for providing temporal teleport capability in a virtual world environment are disclosed. Embodiments of a method for temporally teleporting an avatar in a virtual world environment (VWE) may include, at a first time in a VWE, receiving a request from a user associated with an avatar to temporally teleport the avatar to a temporal destination at an earlier, second time in the VWE. Embodiments of the method may also include creating for the avatar a recreated virtual world based on the temporal destination at the earlier, second time. Embodiments may also include receiving input from the user associated with interaction between the user's avatar and the recreated virtual world and allowing the user's avatar to interactively participate in the recreated virtual world during the temporal teleport.

### FIELD OF INVENTION

The present invention is in the field of data processing systems and, in particular, to systems, methods and media for providing temporal teleport capability in a virtual world environment.

### BACKGROUND

Computer systems are well known in the art and have attained widespread use for providing computer power to many segments of today's modern society. As advances in semiconductor processing and computer architecture continue to push the performance of computer hardware higher, more sophisticated computer software has evolved to take advantage of the higher performance of the hardware, resulting in computer systems that continue to increase in complexity and power. Computer systems have thus evolved into extremely sophisticated devices that may be found in many different settings. Computer systems are often connected to the Internet or other broad-based network in order to communicate with other computer systems, access information or other resources, or perform various tasks associated with business, personal banking, electronic commerce transactions, or other endeavors.

One application for computer systems that is increasing in importance is for use in accessing virtual world environments (VWEs). A VWE represents a real or imaginary place using graphics, images, video, auditory data, or other sensory data to define a representation on a computer system to one or more users. The hardware and software that together create a VWE provide the ability for users to interact with the VWE in various ways. VWEs commonly allow for multiple users to simultaneously interact with the VWE, allowing the users to thus interact with each within the VWE and form a community. Current VWEs such as Second Life® by Linden Lab provide an interactive, three-dimensional (3D) online digital world with hundreds of thousands of users accessing the world via the Internet. In these graphical VWEs, users typically are represented by an avatar within the online world, and the users may command their avatar to move within the VWE, communicate with other users via their avatars, etc., and thus interact with the virtual world. VWEs such as Second Life® allow users (using a client program on their computer system) to use various tools to view, navigate, and modify the virtual world as well as participate in its virtual economy.

Social and business interactions, including both personal and business meetings, are important in VWEs such as Second Life® and are likely to become increasingly important as VWEs continue to become more widespread and sophisticated. To many if not most users, the interactions with other users are their primary reason for participating in the VWE. The ability to interact with other users, as well as the believability of the environment of the virtual world itself, often improves the “realness” and desirability of the virtual world. Enhancements of VWEs that improve interaction with other users or the world itself will serve to make the VWE more useful and commercially valuable.

### SUMMARY OF THE INVENTION

The problems identified above are in large part addressed by systems, methods and media for providing temporal teleport capability in a virtual world environment. A method for temporally teleporting an avatar in a virtual world environment (VWE) is disclosed. Embodiments of the method may include, at a first time in a VWE, receiving a request from a user associated with an avatar to temporally teleport the avatar to a temporal destination at an earlier, second time in the VWE. Embodiments of the method may also include creating for the avatar a recreated virtual world based on the temporal destination at the earlier, second time. Embodiments may also include receiving input from the user associated with interaction between the user's avatar and the recreated virtual world and allowing the user's avatar to interactively participate in the recreated virtual world during the temporal teleport.

Another embodiment provides a computer program product comprising a computer-useable medium having a computer readable program wherein the computer readable program, when executed on a computer, causes the computer to perform a series of operations for providing temporal teleport capability in a virtual world environment. The series of operations generally includes, at a first time in a VWE, receiving a request from a user associated with an avatar to temporally teleport the avatar to a temporal destination at an earlier, second time in the VWE. Embodiments of the series of operations may also include creating for the avatar a recreated virtual world based on the temporal destination at the earlier, second time. Embodiments may also include receiving input from the user associated with interaction between the user's avatar and the recreated virtual world and allowing the user's avatar to interactively participate in the recreated virtual world during the temporal teleport.

A further embodiment provides a data processing system having a machine-accessible medium storing a plurality of program modules. Embodiments may include a data capture system stored on the machine-accessible medium to record events in a virtual world environment. Embodiments may also include a temporal teleport manager stored on a machine-accessible medium to facilitate users of the virtual world environment temporally teleporting an avatar to an earlier time. Embodiments of the temporal teleport manager may include a user interface module to receive requests from a user to temporally teleport an avatar associated with the user to a temporal destination at an earlier time in the VWE. Embodiments of the temporal teleport manager may also include a temporal teleport database interface module to receive stored virtual world environment information associated with the earlier time from a temporal teleport database. Embodiments of the temporal teleport manager may also include an interactive replay module to create a recreated virtual world based on the temporal destination at the earlier time and to allow the user's avatar to interactively participate in the recreated virtual world during a temporal teleport.

### BRIEF DESCRIPTION OF THE DRAWINGS

Aspects of certain embodiments of the invention will become apparent upon reading the following detailed description and upon reference to the accompanying drawings in which like references may indicate similar elements:

FIG. 1 depicts a virtual world environment with a virtual world simulator, a plurality of client computer systems, a world database, and a temporal teleport database according to some embodiments;

FIG. 2 depicts a block diagram of one embodiment of a computer system suitable for use as a component of the virtual world system, such as a client computer system or a data processing system to execute the virtual world simulator;

FIG. 3 depicts a conceptual illustration of software components of a temporal teleport manager according to some embodiments;

FIG. 4 depicts an example of a flow chart for performing a temporal teleport of an avatar in a virtual world environment according to some embodiments;

FIG. 5 depicts an example of a flow chart for propagating an object subject to causality restraints according to some embodiments; and

FIG. 6 depicts an example of a flow chart for performing trans-time communication during a temporal teleport according to some embodiments.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims. The descriptions below are designed to make such embodiments obvious to a person of ordinary skill in the art.

Generally speaking, systems, methods and media for providing temporal teleport capability in a virtual world environment are disclosed. Embodiments of the method for temporally teleporting an avatar in a virtual world environment (VWE) may include, at a first time in a VWE, receiving a request from a user associated with an avatar to temporally teleport the avatar to a temporal destination at an earlier, second time in the VWE. Embodiments of the method may also include creating for the avatar a recreated virtual world based on the temporal destination at the earlier, second time. Embodiments may also include receiving input from the user associated with interaction between the user's avatar and the recreated virtual world and allowing the user's avatar to interactively participate in the recreated virtual world during the temporal teleport.

The system and methodology of the disclosed embodiments allow for temporal teleport of a user's avatar to an earlier time (and optionally location) within the VWE. The user, through their avatar, may interactively participate in the VWE at the earlier time, such as by moving or modifying objects, moving through the VWE, or engaging in conversations with other avatars (and their users at the ‘real time’). The user may thus experience the VWE as it existed at an earlier time and interact with the world accordingly, which may be particularly advantageous when the user is able to interact with features of the VWE that no longer exist within the VWE at its current time. Modifications to objects made during the temporal teleport may propagate to the current time, and methodologies for avoiding causality issues are disclosed. The ability to temporally teleport to an earlier time in the VWE may provide the user with enhanced satisfaction and interaction as the user can interact with objects (such as buildings) that have been destroyed or deleted, can watch meetings or sporting events from the past as if they had been there when they first occurred, or interact in any number of other ways.

In general, the routines executed to implement the embodiments of the invention may be part of a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described herein may be identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

While specific embodiments will be described below with reference to particular configurations of hardware and/or software, those of skill in the art will realize that embodiments of the present invention may advantageously be implemented with other substantially equivalent hardware, software systems, manual operations, or any combination of any or all of these. The invention can take the form of an entirely hardware embodiment, an entirely software embodiment or an embodiment containing both hardware and software elements. In a preferred embodiment, the invention is implemented in software, which includes but is not limited to firmware, resident software, microcode, etc. Moreover, embodiments of the invention may also be implemented via parallel processing using a parallel computing architecture, such as one using multiple discrete systems (e.g., plurality of computers, etc.) or an internal multiprocessing architecture (e.g., a single system with parallel processing capabilities).

Aspects of embodiments of the invention described herein may be stored or distributed on computer-readable medium as well as distributed electronically over the Internet or over other networks, including wireless networks. Data structures and transmission of data (including wireless transmission) particular to aspects of the invention are also encompassed within the scope of the invention. Furthermore, the invention can take the form of a computer program product accessible from a computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Each software program described herein may be operated on any type of data processing system, such as a personal computer, server, etc. A data processing system suitable for storing and/or executing program code may include at least one processor coupled directly or indirectly to memory elements through a system bus. The memory elements may include local memory employed during execution of the program code, bulk storage, and cache memories which provide temporary storage of at least some program code in order to reduce the number of times code must be retrieved from bulk storage during execution. Input/output (I/O) devices (including but not limited to keyboards, displays, pointing devices, etc.) may be coupled to the system either directly or through intervening I/O controllers. Network adapters may also be coupled to the system to enable the data processing system to become coupled to other data processing systems or remote printers or storage devices though intervening private or public networks, including wireless networks. Modems, cable modems and Ethernet cards are just a few of the currently available types of network adapters.

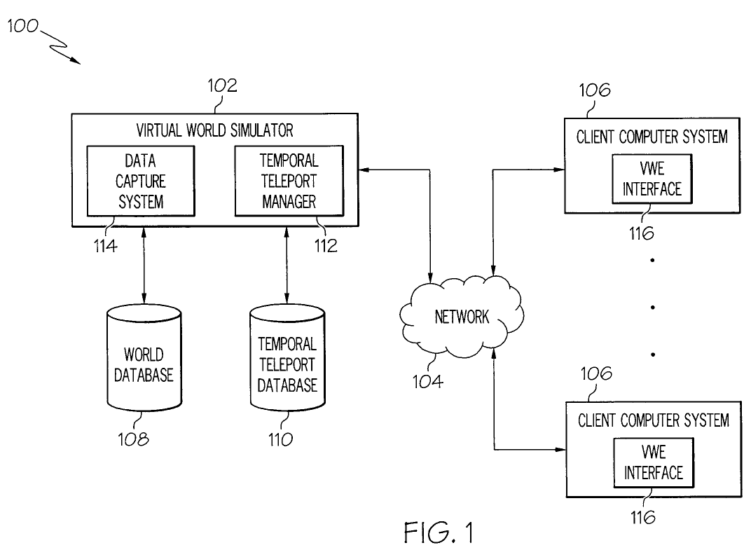

Turning now to the drawings, FIG. 1 depicts a virtual world system with a virtual world simulator, a plurality of client computer systems, a world database, and a temporal teleport database according to some embodiments. In the depicted embodiment, the virtual world system 100 includes a virtual world simulator 102 in communication with a plurality of client computer systems 106 via network 104. The virtual world simulator 102 may also be in communication with databases such as a world database 108 and a temporal teleport database 110. As will be described in more detail subsequently, the virtual world simulator 102 may manage a virtual world environment (VWE) by interacting with a variety of users of client computer systems 106 and by accessing stored information for VWE current operations (in world database 108) and for VWE temporal teleport operations (in temporal teleport database 110).

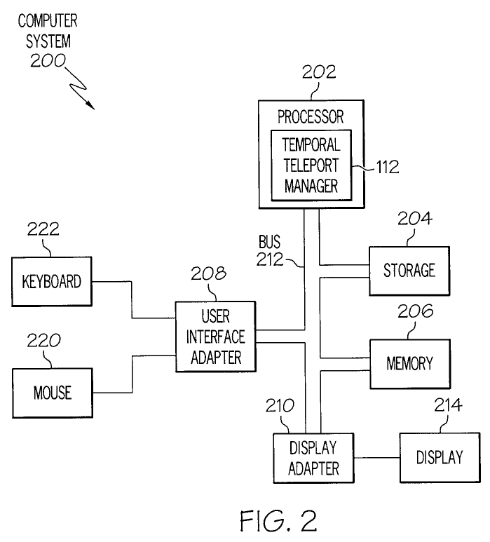

Virtual world simulator 102 may be implemented on one or more servers or other computer systems (such as those described in relation to FIG. 2) adapted to implement all or part of a VWE. The virtual world simulator 102 may be implemented, for example, on one or more application servers such as International Business Machine's (IBM®'s) WebSphere® Application Server (WAS) that may serve as middleware to set up, operate, and integrate e-business applications across multiple computing platforms using Web technologies. The virtual world simulator 102 may provide a VWE to users by accessing stored information from the world database 108 and creating and operating a virtual world based on the stored world environment information. An example virtual world simulator 102 may include massively multiplayer online games such as the Second Life® virtual world from Linden Lab. The virtual world simulator 102 of the disclosed embodiments also includes a data capture system 114 and temporal teleport manager 112 to facilitate temporal teleport by users (typically via their avatars) within the VWE, as will be described in more detail subsequently.

Users may utilize a client computer system 106 according to the present embodiments to access the virtual world simulator 102 (and thus the VWE) via network 104. Client computer system 106 may be a personal computer system or other computer system adapted to execute computer programs, such as a personal computer, workstation, server, notebook or laptop computer, desktop computer, personal digital assistant (PDA), mobile phone, wireless device, or set-top box, such as described in relation to FIG. 2. A user of the client computer system 106 may utilize a VWE interface 116 to interact with the VWE operated by the virtual world simulator 102. VWE interface 116 may be dedicated client software provided by the VWE operator in some embodiments or it may alternatively be existing general software such as a browser.

Network 104 may be any type of data communications channel or combination of channels, such as the Internet, an intranet, a LAN, a WAN, an Ethernet network, a wireless network, telephone network, a proprietary network, or a broadband cable network. In one example, the Internet may serve as network 104 the client computer systems 106 and the virtual world simulator 102 may communicate via the Internet using known protocols. Those skilled in the art will recognize, however, that the invention described herein may be implemented utilizing any type or combination of data communications channel(s) without departure from the scope and spirit of the invention.

The world database 108 may store a variety of files used to create, maintain, and operate a VWE (collectively “environment information”), such as graphics files (e.g., buildings, avatars, landscapes, items, etc.), sound files (e.g., environmental sounds, spoken words, etc.), or text files (e.g., configuration information, descriptive information for objects, user information, etc.). The temporal teleport database 110 may similarly include files used to create, maintain, and operate a VWE (together VWE environment information), such as those recorded by a data capture system 114 over time to preserve objects in the VWE for later temporal teleportation. Files associated with a particular building in the VWE, for example, may be stored in the world database 108 while the building exists in the VWE. If the building no longer exists in the VWE (such as if it was destroyed or the user sold her land that included the building), the building files may be stored in the temporal teleport database 110 so that the building can be reconstructed for a temporal teleport, if necessary. The world database 108 and temporal teleport database 110 may each include any type or combination of storage devices, including volatile or non-volatile storage such as hard drives, storage area networks, memory, fixed or removable storage, or other storage devices. The two databases may also be wholly or partially combined in some embodiments and each may be located in a variety of positions within the virtual world system 100, such as being part of the virtual world simulator 102 or its components.

The data capture system 114 of the virtual world simulator 102 may record events in a VWE (i.e., VWE environment information) so that the temporal teleport manager 112 to create a recreated virtual world for use in temporal teleportation. The data capture system 114 may store recorded events in the temporal teleport database 110 for later access by the temporal teleport manager 112. In some embodiments, only certain objects within the VWE are tagged as being available for temporal teleportation and the data capture system 114 in these embodiments restricts itself to those available objects. To record events in the VWE, the data capture system may record any type of information, such as various files that have been deleted or modified in the world database 108, an indication of changes that have been made (i.e., recording the changes instead of the entire file so that the changes can be reversed), or other information.

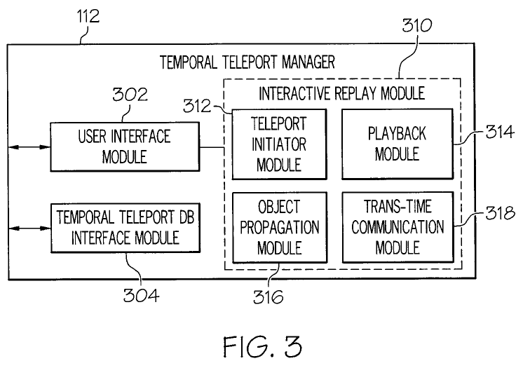

The temporal teleport manager 112 may facilitate users of the VWE temporally teleporting an avatar to an earlier time, as will be described in more detail in relation to FIGS. 3-6. The temporal teleport manager 112 may receive requests from a user to temporally teleport an avatar associated with the user to a temporal destination at an earlier time in the VWE, may access stored VWE environment information associated with the earlier time, and may then create a recreated virtual world based on the temporal destination at the earlier time and allow the user's avatar to interactively participate in the recreated virtual world during a temporal teleport. In some embodiments, the temporal teleport manager 112 may also propagate permitted object configuration changes from the temporal teleport to a current time in the VWE so that certain actions that the user performs during the teleport are reflected in the VWE once they end the teleport. The temporal teleport manager 112 may also in some embodiments facilitate communication between the user's avatar and a second avatar associated with a second user, so that the first user may interactively communicate with another user while on their temporal teleport.

Various non-limiting examples may serve to further illustrate the disclosed virtual world system 100. In one example, a user may wish to revisit a building in the VWE that no longer exists so that the user (through their avatar) can walk around the building, go inside, look at it from different angles, or perform any other action that would have been possible if the virtual building still existed. To do this, the user may request (using their VWE interface 116) a temporal teleport to the building at a time when the building existed. The temporal teleport manager 112 may then recreate the building and its surroundings based on stored VWE environment information and provide the ability for the user's avatar to interact with the restored virtual building. The user may thus experience the virtual building even though the building no longer appears in the VWE.

In another example, a user may wish to revisit a past business meeting (or sporting event, or political speech, or any other event). The temporal teleport manager 112 may, upon receiving such a request, recreate the virtual world surrounding the earlier event using the stored VWE environment information. The user may then view (and listen) to the event as if they were at the event when it originally occurred. In some embodiments, the user may also interact with any avatars that are also at the event by attempting to communicate with the avatars. The user, for example, may attempt to speak with a business colleague's avatar at the recorded meeting, and the temporal teleport manager 112 may then contact the other user to see if this wish to communicate with the teleporting user or even if the other users wishes to teleport to the same meeting. In this fashion, a user may have an enhanced recreation of past events within the VWE.

The ability to interactively participate in the recreated virtual world allows for users to experience the earlier time within the VWE much like they had been there when it actually happened. One aspect of this interaction may include communication with other users (through their avatars), as mentioned previously, which may be provided via trans-time communication with a user still in ‘current time’ or with another user that is temporally teleporting to the same time and place. Users may also interact with their physical environment in various ways, such as by moving, deleting, or changing objects, and a set of propagation rules may help define which of these changes, if any, are propagated to the current time once the temporal teleport is completed.

FIG. 2 depicts a block diagram of one embodiment of a computer system 200 suitable for use as a component of the virtual world system 100, such as a client computer system 106 or a data processing system to execute the virtual world simulator 102. Other possibilities for the computer system 200 are possible, including a computer having capabilities other than those ascribed herein and possibly beyond those capabilities, and they may, in other embodiments, be any combination of processing devices such as workstations, servers, mainframe computers, notebook or laptop computers, desktop computers, PDAs, mobile phones, wireless devices, set-top boxes, or the like. At least certain of the components of computer system 200 may be mounted on a multi-layer planar or motherboard (which may itself be mounted on the chassis) to provide a means for electrically interconnecting the components of the computer system 200.

In the depicted embodiment, the computer system 200 includes a processor 202, storage 204, memory 206, a user interface adapter 208, and a display adapter 210 connected to a bus 212 or other interconnect. The bus 212 facilitates communication between the processor 202 and other components of the computer system 200, as well as communication between components. Processor 202 may include one or more system central processing units (CPUs) or processors to execute instructions, such as an IBM® PowerPC™ processor, an Intel Pentium® processor, an Advanced Micro Devices Inc. processor or any other suitable processor. The processor 202 may utilize storage 204, which may be non-volatile storage such as one or more hard drives, tape drives, diskette drives, CD-ROM drive, DVD-ROM drive, or the like. The processor 202 may also be connected to memory 206 via bus 212, such as via a memory controller hub (MCH). System memory 206 may include volatile memory such as random access memory (RAM) or double data rate (DDR) synchronous dynamic random access memory (SDRAM). In the disclosed systems, for example, a processor 202 may execute instructions to perform functions of the temporal teleport manager 112, such as by receiving generating recreated virtual worlds in response to a request from a user, and may temporarily or permanently store information during its calculations or results after calculations in storage 204 or memory 206. All or part of the temporal teleport manager 112, for example, may be stored in memory 206 during execution of its routines. Similarly, processor 202 may execute instructions for the VWE interface 116 when computer system 200 is used for a client computer system 106.

The user interface adapter 208 may connect the processor 202 with user interface devices such as a mouse 220 or keyboard 222. The user interface adapter 208 may also connect with other types of user input devices, such as touch pads, touch sensitive screens, electronic pens, microphones, etc. A user of a client computer system 106 requesting a temporal teleport, for example, may utilize the keyboard 222 and mouse 220 to interact with their computer system. The bus 212 may also connect the processor 202 to a display 214, such as an LCD display or CRT monitor, via the display adapter 210.

FIG. 3 depicts a conceptual illustration of software components of a temporal teleport manager 112 according to some embodiments. The temporal teleport manager 112 may be implemented on a computer system 200 such as described in relation to FIG. 2, including on one or more servers. As described previously, the temporal teleport manager 112 may facilitate users of the VWE temporally teleporting an avatar to an earlier time by receiving requests from a user to temporally teleport an avatar associated with the user to a temporal destination at an earlier time in the VWE, accessing stored VWE environment information associated with the earlier time, and creating a recreated virtual world based on the temporal destination at the earlier time and allowing the user's avatar to interactively participate in the recreated virtual world during a temporal teleport. The temporal teleport manager 112 may include components to assist it with its functions, including a user interface module 302, a temporal teleport database interface module 304, and an interactive replay module 310. The interactive replay module 310 itself may include its own components, such as a teleport initiator module 312, a playback module 314, an object propagation module 316, and a trans-time communication module 318. One of ordinary skill in the art will recognize that the functionality of each component of the temporal teleport manager 112 may be combined or divided in any fashion and the description herein is merely intended to be illustrative of some embodiments.

The user interface module 302 may facilitate communication to and from a user, including transmitting and receiving information associated with a temporal teleport of the user's avatar. The temporal teleport database interface module 304 may facilitate communication to and from the temporal teleport database 110, such as when the temporal teleport manager 112 accesses stored VWE environment information in the temporal teleport database 110 in order to create a recreated virtual world.

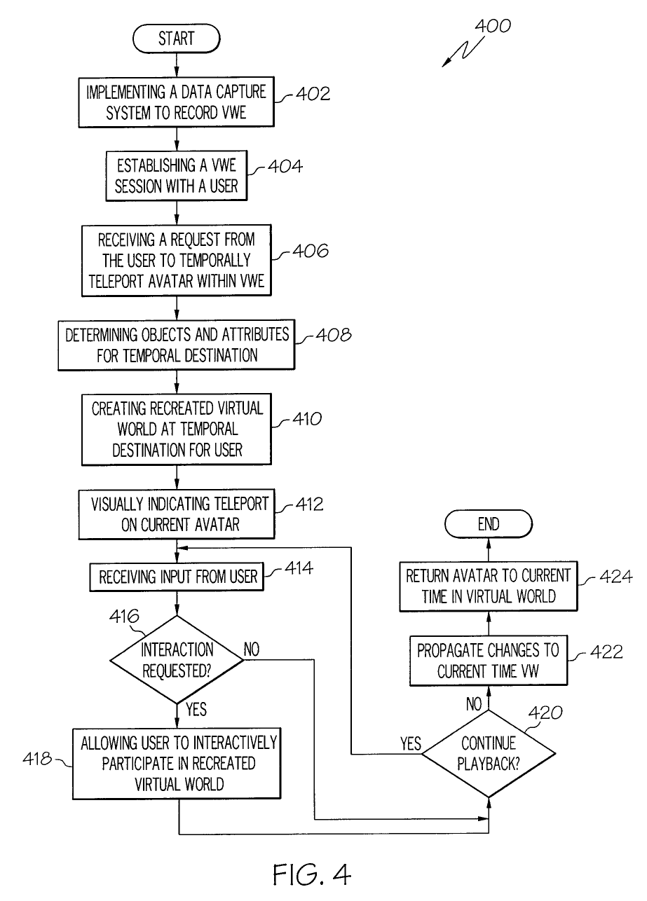

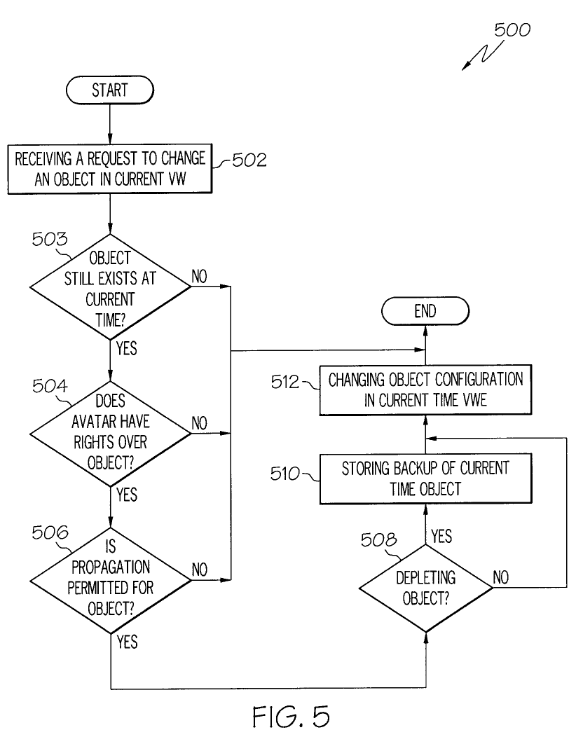

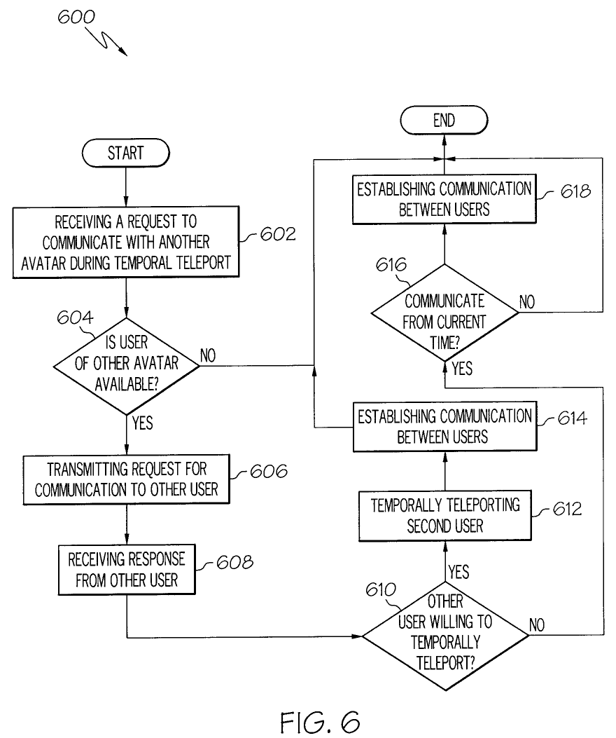

The interactive replay module 310, and its components, may communicate with the two interface modules to assist it in performing temporal teleport for a user as well as various related tasks. The teleport initiator module 312 may create a recreated virtual world and initiate a temporal teleport to that world in response to a user request, as will be described in more detail in relation to FIG. 4. The playback module 314 may receive user inputs during the temporal teleport to control the playback of interaction, such as by allowing the user to play, pause, rewind, fast forward, or perform other actions (including options available on playback devices such as digital video recorders). A user watching a sporting event during a temporal teleport, for example, may ‘fast forward’ to a more exciting part of the game with the assistance of the playback module 314. The object propagation module 316 may assist in preventing causation problems from the user's interactive temporal teleport by controlling the type and nature of changes that will be propagated back to ‘real time’ after a temporal teleport is complete, as will be described in more detail in relation to FIG. 5. The trans-time communication module 318 may facilitate communication between a user's avatar and other avatars associated with other users so that the first user may interactively communicate with other users while on their temporal teleport, as will be described in more detail in relation to FIG. 6.

FIG. 4 depicts an example of a flow chart 400 for performing a temporal teleport of an avatar in a virtual world environment according to some embodiments. The method of flow chart 400 may be performed, in one embodiment, by components of the virtual world simulator 102, such as the temporal teleport manager 112 and data capture system 114, as well as their components. Flow chart 400 begins with element 402, implementing a data capture system to record a VWE. In some embodiments, a data capture system 114 may perform element 402 by recording changes in a VWE over time so that past states of the VWE may be recreated in a temporal teleport, as described previously. The recorded VWE environment information may be stored in a temporal teleport database 110 in some embodiments. In some embodiments, the VWE environment information may be captured at predefined periods (e.g., once every 5 seconds, once every minute, etc.) in a similar way to how backups are performed in the current art, while in other embodiments every change in the environment may be recorded.

If it is desired to refrain from recording all VWE environment information in order to conserve storage resources, a subset of the information may be stored. One example limitation to reduce storage space required would be to restrict the areas within the VWE that are eligible for temporal teleporting, such as by region, an area on the ground, or other grouping of objects for which events should be recorded. Another example limitation would be restrict the number of objects in the VWE for which events are recorded, such as by limiting recording to one or more of land, inventory items, trees, building, or other objects. Similarly, the movement of other avatars may not be recorded in some embodiments. In this example, an avatar performing a temporal teleport would be able to see motion and configuration for some objects while other objects would appear stationary or not appear at all. In yet another example limitation, the amount of time in the past to which an avatar may teleport may be restricted. Storing only 30 days of history in the rolling data capture system 114, for example, would require less space than storing 90 days. In this example, events older than the time limit could be purged from the temporal teleport database 110 in a first-in/first-out queue. One of ordinary skill in the art will recognize that any combination of these limitations, as well as other limitations or no limitations at all, may be applied to the recorded VWE environment information.

The virtual world simulator 102 may at element 404 establish a VWE session with a user of a client computer system 106. The establishment of a session between a user and the virtual world simulator 102 may be performed in any fashion, such as by receiving a request and authentication information (e.g., user id and password) from a user and assigning a session id to the user session. After the session has been established, the user may utilize their avatar to interact with the VWE in their normal fashion. At element 406, the virtual world simulator 102 may receive a request from the user to temporally teleport their avatar to a temporal destination within the VWE. The user may request a temporal teleport in any number of fashions, such as by entering a keyboard command, selecting a temporal teleport from a pull down list or menu, entering or approaching a specific object in the VWE (e.g., a temporal teleport door), or other means. The user may request a temporal teleport to a particular time (e.g., Jul. 4, 2006, 10 pm or 30 days ago), a particular state of being (e.g., when this building still existed), a random time, or any other time. The user may also optionally request a temporal destination that includes a geographical location in addition to a time, such as by requesting to go to a particular location or type of location or by requesting to remain in their present location.

Once a request for a temporal teleport has been received, the temporal teleport manager 112 (and its interactive replay module 310) may at element 408 determine the objects and attributes associated with the temporal destination and, at element 410, create a recreated virtual world for the user based on the temporal destination. The interactive replay module 310 may create the recreated virtual world based on stored VWE environment information located in the temporal teleport database 110. In some embodiments, only a portion of the recreated virtual world is actually created as the interactive replay module 310 may determine how much of the world will reasonably be required by the user during the temporal teleport. The interactive replay module 310 may create, for example, a recreated virtual world that includes a building and its immediate surroundings (and the appropriate time) in response to a teleport to that building. If the user's avatar leaves that building, in this example, additional parts of the virtual world may be optionally recreated so as to provide a seamless experience to the user. The user's avatar in the current time (i.e., the ‘real time’ of the VWE and where the user teleported from) may optionally at element 412 be provided a visual or other indication that the user is on a temporal teleport, such as by freezing, ‘graying out’, or otherwise indicating that the avatar is not active.

At this point, the user is effectively transported in time (and optionally place) within the virtual world. The user may command their avatar to perform various actions within the recreated virtual world and interact with the world as they would if it were during the current time instead of a temporal teleport. When input from a user is received at element 414, the interactive replay module 310 may determine if interaction between the avatar and the recreated virtual world is requested at decision block 416. If no interaction is requested (such as if the avatar is stationary or the avatar is moving without impacting other objects), flow chart 400 continues to decision block 420, where playback either continues or terminates. If interaction is requested, the interactive replay module 310 may at element 418 allow the user to interactively participate in the recreated virtual world. In some embodiments, the user (through their avatar) may interact with the recreated virtual world in the same fashion as they would if it were not recreated, such as by moving their avatar, performing actions on objects (e.g., moving, changing, deleting, etc), or communicating with other avatars. For attempts to establish communication with another avatar during the temporal teleport, the interactive replay module 310 facilitate such communication by providing trans-time communication or temporally teleporting the other user, as will be described in relation to FIG. 6.

At decision block 420, the interactive replay module 310 determines whether playback of the recreated virtual world is ongoing. If so, the method returns to element 414 to receive user input and if not, the method continues to element 422 for further processing. Once playback is complete, the interactive replay module 310 may at element 422 propagates any changes made to objects to the current time VWE, subject to the causation restrictions described in relation to FIG. 5. Also at element 422, any permitted objects that the user has acquired during the temporal teleport to the current time VWE so that the user has such objects in the current time. In some embodiments, such action may be limited by the causality restrictions described in relation to FIG. 5. At element 424, the avatar is returned to the current time in the VWE and the method terminates. Once the temporal teleport is over, the user may interact normally with the current time VWE or request to perform another temporal teleport to an earlier time.

FIG. 5 depicts an example of a flow chart 500 for propagating an object subject to causality restraints according to some embodiments. The method of flow chart 500 may be performed, in one embodiment, by components of the temporal teleport manager 112, such as the object propagation module 316. Propagation of an object subject to causality restraints may be associated with element 422 as described in relation for FIG. 4. The process of flow chart 500 may be repeated for each object for which the configuration changed during the temporal teleport. Flow chart 500 begins with element 502, receiving a request to change an object or the configuration of an object in the current VWE based on changes made during a temporal teleport. This may occur, for example, if a user commands their avatar during a temporal teleport to make changes to objects, and the method of flow chart 500 determines whether such changes are propagated to the current time. In another example, the request may concern an object or item that the user's avatar attempts to bring back from the temporal teleport to the current time VWE. Determining whether object propagation is an issue may be beneficial in eliminating causation issues that result from the ‘time travel’ of temporal teleporting.

At decision block 502, the object propagation module 316 may determine if the object to be changed still exists at the current time (i.e., within the current VWE environment). If the object to be changed no longer exists, causality will not be an issue and the object need not be (and cannot be) changed. In this case, the method may terminate or return to element 502 for processing additional objects. If the object to be changed still exists, the method continues to decision block 504.

At decision block 504, the object propagation module 316 may determine if the avatar that is causing the requested change has a right to do so for the particular object. If the avatar does not have such rights, the method may terminate or continue to the next object. If the avatar does have such rights, the method continues to decision block 506. In some embodiments, only owners of an object may be permitted to change the object such that changes are propagated. In other embodiments, any user may make such changes or a limited group may be allowed or prevented from doing so.

At decision block 506, the object propagation module 316 may determine if propagation is permitted for the object. If propagation is not permitted, the method terminates or continues to the next object. If propagation is permitted, the method may continue to decision block 508. In some embodiments, particular objects may have an indication of whether changes to their configuration may be propagated, such as by the use of a propagation tag or other mechanism. In other embodiments, some changes for an object may be allowed while others are not permitted (e.g., cannot delete but can move). In other embodiments, point in time voting involving users who have an interest in the object can be enabled to determine if propagation will be permitted. If an avatar moves three chairs during a temporal teleport, the object propagation module 316 may optionally poll three other users currently using those chairs in the current time VWE to determine if they acquiesce to the chairs being moved in the current time. Various voting strategies could be employed so that an owner or specially designated users have extra votes.

The object propagation module 316 may next determine at decision block 508 whether the object to be changed is a depleting object. A depleting object is an object that, if deleted in the virtual world, the object remains deleted. A depleting object may be considered to be similar to the concept of a ‘call by reference’ or symbolic links in UNIX where pointers to the same object can be manipulated but the object itself remains the same. A non-depleting object is an object within the VWE that can be copied and replicated such that two or more instantiations of the same object can exist. A non-depleting object may be considered similar to the concept of ‘call by value’ or physically copying a file in UNIX where an object can be copied multiple times and where changes to one copy will not affect the others. An example depleting object would be an original piece of virtual art and an example non-depleting object would be a word processor document that can be replicated and passed around without affecting the original copy.

If, at decision block 508, the object is determined to be a non-depleting object, the method continues to element 512, where the object propagation module 316 changes the object configuration in the current time VWE, after which the method either terminates or continues with the next object. The object changes are thus propagated at element 512 and any changes may be immediately made in the current time VWE. If a user, for example, moved a chair from one corner of the room to another while on temporal teleport, and the chair object was allowed to be modified by the user and propagated forward, the chair would appear to instantaneously move to its position when the temporal teleport ended according to some embodiments.

If, at decision block 508, the object is determined to be a depleting object, the method continues to element 510, storing a backup of the current time object so that any changes can be reversed. After storing the backup, the method continues to element 512, where the object propagation module 316 changes the object configuration in the current time VWE, after which the method either terminates or continues with the next object. The object changes are thus propagated at element 512 and any changes may be immediately made in the current time VWE, as described previously. The various decision blocks of FIG. 5 represent one example order and choice of decisions related to propagation of a change to an object configuration, and one of ordinary skill in the art will recognize that other combinations and/or orders may also be used.

In order to prevent causality problems, the object is not changed at any times in between the end of the temporal teleport and the current time VWE. For example, suppose an avatar visited a virtual world as it existed two weeks in the past and moved a chair. Another avatar that visits the world as it existed one week ago will still see the chair in its original position when it was first recorded by the data capture system 114. This helps prevent major causality problems of having to undo actions that would not have been possible had the object been moved during the interim timeframe. In another example, consider an avatar who forgets to lock his virtual house and a second avatar that enters this unprotected structure and steals an object. In some embodiments, it is not logically possible to temporally teleport to a time before the theft and lock the door to prevent the theft as the theft has already occurred. The first avatar could, however, teleport to the earlier time and make a copy of a non-depleting object before its theft, which, assuming the object was otherwise permitted to be propagated, would result in both the original owner and the burglar in having a copy of the object.

FIG. 6 depicts an example of a flow chart 600 for performing trans-time communication during a temporal teleport according to some embodiments. The method of flow chart 600 may be performed, in one embodiment, by components of the temporal teleport manager 112, such as the trans-time communication module 318. Performance of trans-time communication may be considered a form of interactive participation as described in relation for element 418 of FIG. 4 and may occur when a user desires to communicate with an avatar that they encounter during a temporal teleport. Flow chart 600 begins with element 602, receiving a request to communicate with another avatar during a temporal teleport. The request from a teleporting avatar may be received in a variety of ways, such as by the avatar attempting to communicate with another avatar, the user of the avatar selecting an option from a pull-down list, or other means. The request may include a request to communicate with the other user via trans-time communication and/or may optionally request for the other user to temporally teleport to the same time within the VWE. A user may desire to establish the communication if, for example, the user wished to ask questions of a presenter for follow-up or clarification of the presentation. Because the user's avatar is living in the recreated virtual world rather than the current time VWE, the avatar cannot affect the actions of the presenter during the replay but can request communication with the presenter. In some embodiments, the replay of the temporal teleport may be paused while the trans-time communication occurs.

For trans-time communication to occur, the other user needs to be available for interactive communication. If the trans-time communication module 318 determines at decision block 604 that the user is not available, the method may simply terminate or, optionally, a voice, text or other message may be left for the second user. A user may be considered available for communication by a variety of standards, such as if they are currently on-line in the VWE, if they do not have a ‘do not disturb’ tag activated, if they have e-mail, mobile phone, chat or other means of communication available, etc. If the trans-time communication module 318 determines that the user of the other avatar is available, the method of flow chart 600 may continue to element 606, transmitting a request for communication to the other user. At element 608, the response from the other user may be received. The response may include an indication of whether the other user will communicate, in what fashion they are willing to communicate, whether they are willing to temporally teleport in order to communicate ‘in person’, or other information. The transmission and response of elements 606 and 608 may be performed using any communication technology known or later developed, including chat, instant messaging, e-mail, voice communication, etc.

If the other user is willing to temporally teleport at decision block 610, the interactive replay module 310 may temporally teleport the second user 612 to the recreated virtual world so that the communication between the two users can be established at element 614, after which the method may terminate. When the second user is temporally teleported, their avatar may be rendered alongside the avatar of the first user and the two avatars may then perform a dialog. Once the conversation is finished, the other user may then request to be rendered back into the current time VWE and the first avatar can continue with their temporal teleport in the recreated virtual world. This conversation may optionally be recorded so that it can be replayed, but in some embodiments this conversation is not recorded so as to reduce the possibility of causality problems. If the conversation is recorded, it may be presented as an alternative virtual world that can also be selected for temporal teleport, resulting in the possibility of a user being able to select from multiple saved virtual world experiences.

If the other user is not willing to temporally teleport at decision block 610, the trans-time communication module 318 may determine if the second user is willing to communicate from the current time VWE at decision block 616 (based on the response received at element 608). If the second user is willing to communicate, the trans-time communication module 318 may establish the communication between the users and their avatars at element 618, after which the method may terminate.

It will be apparent to those skilled in the art having the benefit of this disclosure that the present invention contemplates methods, systems, and media for providing temporal teleport capability in a virtual world environment. It is understood that the form of the invention shown and described in the detailed description and the drawings are to be taken merely as examples. It is intended that the following claims be interpreted broadly to embrace all the variations of the example embodiments disclosed.

What is claimed is:

1. A method for temporally teleporting an avatar in a virtual world environment, the method comprising:
at a first time in a virtual world environment, receiving a request from a user associated with an avatar to temporally teleport the avatar to a temporal destination at an earlier, second time in the virtual world environment;
creating for the avatar a recreated virtual world based on the temporal destination at the earlier, second time;
receiving input from the user associated with interaction between the user's avatar and the recreated virtual world; and
allowing the user's avatar to interactively participate in the recreated virtual world during the temporal teleport.

2. The method of claim 1, further comprising returning the avatar to a current time in the virtual world environment after completion of the temporal teleport.

3. The method of claim 2, further comprising propagating a permitted object configuration change from the temporal teleport to the current time in the virtual world environment.

4. The method of claim 3, wherein the permitted object configuration change comprises a modification of a configuration of an object of the virtual world environment.

5. The method of claim 3, wherein the permitted object configuration change comprises retrieving an object from temporal teleport to the current time of the virtual world environment.

6. The method of claim 1, further comprising before receiving the temporal teleport request, establishing a virtual world environment session between the user and the virtual world environment.

7. The method of claim 1, further comprising before receiving the temporal teleport request, implementing a data capture system to record events in the virtual world environment.

8. The method of claim 1, further comprising visually indicating that the avatar has temporally teleported.

9. The method of claim 1, wherein the temporal destination further comprises a geographical location of the virtual world environment in addition to the earlier, second time.

10. The method of claim 1, wherein creating for the avatar the recreated virtual world comprises accessing a recorded virtual world environment to assist in creating the recreated virtual world.

11. The method of claim 1, wherein allowing the user's avatar to interactively participate in the recreated virtual world during the temporal teleport comprises allowing the user's avatar to modify a configuration of an object in the recreated virtual world.

12. The method of claim 1, wherein allowing the user's avatar to interactively participate in the recreated virtual world during the temporal teleport comprises allowing the user's avatar to communicate with an avatar associated with a different user.

13. A computer program product comprising a computer-useable medium having a computer readable program, wherein the computer readable program when executed on a computer causes the computer to:
at a first time in a virtual world environment, receiving a request from a user associated with an avatar to temporally teleport the avatar to a temporal destination at an earlier, second time in the virtual world environment;
creating for the avatar a recreated virtual world based on the temporal destination at the earlier, second time;
receiving input from the user associated with interaction between the user's avatar and the recreated virtual world; and
allowing the user's avatar to interactively participate in the recreated virtual world during the temporal teleport.

14. The computer program product of claim 13, further comprising returning the avatar to a current time in the virtual world environment after completion of the temporal teleport.

15. The computer program product of claim 14, further comprising propagating a permitted object configuration change from the temporal teleport to the current time in the virtual world environment.

16. A data processing system having a machine-accessible medium storing a plurality of program modules, the system comprising:
a data capture system stored on a machine-accessible medium to record events in a virtual world environment; and
a temporal teleport manager stored on a machine-accessible medium to facilitate users of the virtual world environment temporally teleporting an avatar to an earlier time, the temporal teleport manager comprising:
a user interface module to receive requests from a user to temporally teleport an avatar associated with the user to a temporal destination at an earlier time in the virtual world environment;
a temporal teleport database interface module to access, from a temporal teleport database, stored virtual world environment information associated with the earlier time; and
an interactive replay module to create a recreated virtual world based on the temporal destination at the earlier time and to allow the user's avatar to interactively participate in the recreated virtual world during a temporal teleport.

17. The system of claim 16, further comprising a temporal teleport database.

18. The system of claim 16, wherein the interactive replay module further comprises an object propagation module to propagate a permitted object configuration change from the temporal teleport to a current time in the virtual world environment.

19. The system of claim 16, wherein the interactive replay module further comprises a trans-time communication module to facilitate communication between the user's avatar and a second avatar associated with a second user.

20. The system of claim 16, wherein the interactive replay module further comprises a playback module to manager user input associated with the user's interactive participation in the recreated virtual world.
